(19) United States
(12) Patent Application Publication
(10) Pub. No.: US 2018/0188034 A1
(43) Pub. Date: Jul. 5, 2018

(54) ESCAPE ROUTE GENERATING METHOD, DEVICE AND SYSTEM

(71) Applicant: BOE TECHNOLOGY GROUP CO., LTD., Beijing (CN)

(72) Inventor: Ran DUAN, Beijing (CN)

(73) Assignee: BOE TECHNOLOGY GROUP CO., LTD., Beijing (CN)

(21) Appl. No.: 15/698,166

(22) Filed: Sep. 7, 2017

(30) Foreign Application Priority Data
Jan. 3, 2017 (CN) 201710002108.8

(51) Int. Cl. G01C 21/20; G08B 17/00; G01S 1/68; H04W 4/02

(52) U.S. Cl. CPC G01C 21/206; H04W 4/02; G01S 1/68; G08B 17/00

(57) ABSTRACT

An escape route generating method, device and system. The escape route generating method includes: acquiring an initial route map by identifying identification information of an identification node; receiving fire parameter information; generating an escape route according to the fire parameter information and the initial route map; and providing the escape route.

### TECHNICAL FIELD

Embodiments of the present disclosure relate to an escape route generating method, an escape route generating device and an escape route generating system.

### BACKGROUND

At present, when a fire occurs in interior of a building, people often make a judgment according to a scene situation seen by themselves, and find a safe route to leave the building. However, people often do not know an exact location of the fire in the building and a spreading situation of the disaster, and sometimes make a wrong judgment to choose a route which is not conducive to safe departure from the building.

### SUMMARY

At least an embodiment of the disclosure provides an escape route generating device, comprising: a processor and a memory, wherein the memory is used for storing instructions. When the instructions are executed by the processor, operations are implemented including: acquiring an initial route map by identifying identification information of an identification node; receiving fire parameter information; generating an escape route according to the fire parameter information and the initial route map; and providing the escape route.

For example, when the instructions are executed by the processor, further operations are implemented including: identifying two-dimensional code information on the identification node, and establishing a wireless connection with the identification node; and initiating a pairing request to the identification node and completing the pairing, and transmitting an identification state request to the identification node, the identification state request being used for acquiring the fire parameter information from the identification node.

For example, the initial route map includes passageway information arranged and identification nodes laid out in respective floors; and the fire parameter information includes temperature-related information sensed by respective identification nodes in regions where the respective identification nodes are located.

For example, when the instructions are executed by the processor, further operations are implemented including: filtering the identification nodes laid out on the initial route map according to the received fire parameter information to obtain escape identification nodes; and marking the escape identification nodes on the initial route map to generate an escape route map.

For example, the fire parameter information includes temperature data from a plurality of identification nodes, wherein a total amount of the temperature data is smaller than or equal to a total amount of the identification nodes laid out on the initial route map.

For example, when the instructions are executed by the processor, further operations are implemented including: taking identification nodes whose temperature data is lower than a safety threshold as the escape identification nodes, and deleting identification nodes whose temperature data is higher than the safety threshold, wherein when the total amount of the temperature data is smaller than the total amount of the identification nodes laid out on the initial route map, identification nodes having no temperature data corresponding thereto are deleted.

For example, the fire parameter information includes binary data from the plurality of identification nodes, a total number of digits of the binary data is smaller than or equal to the total amount of the identification nodes laid out on the initial route map, and each binary digit in the binary data is used for representing whether or not a corresponding identification node is passable.

For example, when the instructions are executed by the processor, further operations are implemented including: taking an identification node with a binary digit of 1 as an escape identification node if the binary digit of 1 represents “passable”; or taking an identification node with a binary digit of 0 as the escape identification node if the binary digit of 0 represents “passable”.

For example, when the instructions are executed by the processor, further operations are implemented including: taking an image in a position where the identification node is located, and performing direction guidance with an arrow on the image.

At least an embodiment of the disclosure provides an escape route generating system comprising: an identification node, and the escape route generating device described above; wherein: the identification node is represented by identification information, and the identification information is used for storing an initial route map; the identification node is further configured to receive and store temperature-related data from other identification nodes, and acquire fire parameter information of the identification node; and each of the identification nodes is further configured to establish a wireless connection in response to identification of the escape route generating device.

For example, each identification node located on the initial route map transmits the temperature-related data stored in the identification node to neighboring identification nodes in a one-level-to-one-level spread-out approach, so that each identification node located on the initial route map has the fire parameter information stored thereon.

For example, each identification node periodically transmits the temperature-related data related to a region where the identification node is located to adjacent identification nodes.

For example, when a certain identification node establishes the wireless connection with the escape route generating device, the certain identification node then transmits a request instruction to an adjacent identification node so as to acquire the temperature data related to the fire parameter information.

At least an embodiment of the disclosure provides an escape route generating method, comprising: acquiring an initial route map by identifying identification information of an identification node; receiving fire parameter information; generating an escape route according to the fire parameter information and the initial route map; and providing the escape route.

For example, the escape route generating method further comprises: identifying two-dimensional code identification information on the identification node, and establishing a wireless connection with the identification node. The receiving fire parameter information includes: initiating a pairing request to the identification node and completing the pairing; and transmitting an identification state request to the identification node, wherein the identification state request is used for acquiring the fire parameter information from the identification node.

For example, the initial route map includes passageway information arranged and identification nodes laid out in respective floors; the fire parameter information includes temperature-related information sensed by respective identification nodes at regions where the respective identification nodes are located. The generating an escape route according to the fire parameter information and the initial route map, includes: filtering the identification nodes laid out on the initial route map according to the received fire parameter information to obtain escape identification nodes; and marking the escape identification nodes on the initial route map to generate an escape route map.

For example, the fire parameter information includes temperature data from a plurality of identification nodes, and a total amount of the temperature data is smaller than or equal to a total amount of the identification nodes laid out on the initial route map. The filtering the identification nodes laid out on the initial route map according to the received fire parameter information to obtain escape identification nodes, includes: taking identification nodes whose temperature data is lower than a safety threshold as escape identification nodes, deleting identification nodes whose temperature data is higher than the safety threshold; wherein when the total amount of the temperature data is smaller than the total amount of the identification nodes laid out on the initial route map, identification nodes having no temperature data corresponding thereto are deleted.

For example, the fire parameter information includes binary data from the plurality of identification nodes, a total number of digits of the binary data is smaller than or equal to a total amount of the identification nodes laid out on the initial route map, and each binary digit in the binary data is used for representing whether or not a corresponding identification node is passable.

For example, the filtering the identification nodes laid out on the initial route map according to the received fire parameter information to obtain escape identification nodes, includes: taking an identification node with a binary digit of 1 as an escape identification node if the binary digit of 1 represents passable; or taking an identification node with a binary digit of 0 as the escape identification node if the binary digit of 0 represents passable.

For example, the providing the escape route includes: acquiring an image in a position where the identification node is located; and performing direction guidance with an arrow on the image.

### BRIEF DESCRIPTION OF THE DRAWINGS

In order to illustrate the technical solutions in the embodiments of the present disclosure more clearly, the drawings needed to be used in the description of the embodiments will be briefly described in the following. It is obvious that the drawings described below are only related to some embodiments of the present disclosure, and are not intended to be limitative to the disclosure.

FIG. 1 is a schematic diagram of an escape route system provided by an embodiment of the present disclosure;

FIG. 2A is a flow chart of an escape route generating method provided by an embodiment of the present disclosure;

FIG. 2B is a schematic diagram of a map escape route provided by an embodiment of the present disclosure;

FIG. 2C is a schematic diagram of an escape route indicated with arrows provided by an embodiment of the present disclosure;

FIG. 3 is an implementation flow chart of steps of acquiring fire parameter information via a Bluetooth wireless connection provided by an embodiment of the present disclosure;

FIG. 4 is an implementation flow chart of steps of generating a route map provided by an embodiment of the present disclosure;

FIG. 5A is a schematic diagram of an escape route generating device provided by an embodiment of the present disclosure;

FIG. 5B is another schematic diagram of an escape route generating device provided by an embodiment of the present disclosure;

FIG. 6 is a schematic block diagram of an identification node provided by an embodiment of the present disclosure; and

FIG. 7 is a schematic flow chart of generating an escape route map with a mobile phone and an identification node provided by an embodiment of the present disclosure.

### DETAILED DESCRIPTION

Hereinafter, the technical solutions of the embodiments of the present disclosure will be described in a clearly and fully understandable way in conjunction with the drawings related to the embodiments of the present disclosure; with reference to non-restrictive exemplary embodiments shown in the drawings and described in detail in the following description, exemplary embodiments of the present disclosure and their various features and favorable details are illustrated more comprehensively. It should be noted that, the features shown in the drawings are not necessarily drawn according to scale. Known materials, components and process technologies are not described in the present disclosure so as not to obscure the exemplary embodiments of the present disclosure. Examples given are merely intended to facilitate understanding of implementation of exemplary embodiments of the present disclosure, and further enable those skilled in the art to implement the exemplary embodiments. Therefore, the examples should not be construed as limiting the scope of the exemplary embodiments of the present disclosure.

Unless otherwise defined, technical terms or scientific terms used in the present disclosure should be of general meaning as understood by those ordinarily skilled in the art. “First”, “second” and similar words used in the present disclosure do not represent any sequence, quantity or importance and merely intend to differentiate different composite parts. In addition, in respective embodiments of the present disclosure, same or similar reference signs denote same or similar parts.

Hereinafter, specific implementations of an escape route generating method, device and system provided by the embodiments of the present disclosure will be illustrated in detail in conjunction with the drawings.

An embodiment of the present disclosure provides a method for implementing escape route planning and guidance by installing an application (APP) on a client. For example, in embodiments of the present disclosure, by connecting a smart apparatus with identification nodes laid out in a building, fire parameter information may be acquired and an escape route map may be generated.

A smart client in embodiments of the present disclosure may be a control terminal of a smart apparatus, a user may use the smart client to implement wireless connection with an identification node through a network such as 3G/4G, WIFI and so on. In embodiments of the present disclosure, the fire parameter information from the connected identification node is processed by the application (app) on the smart client, and a safe escape route map is further generated and provided to the user.

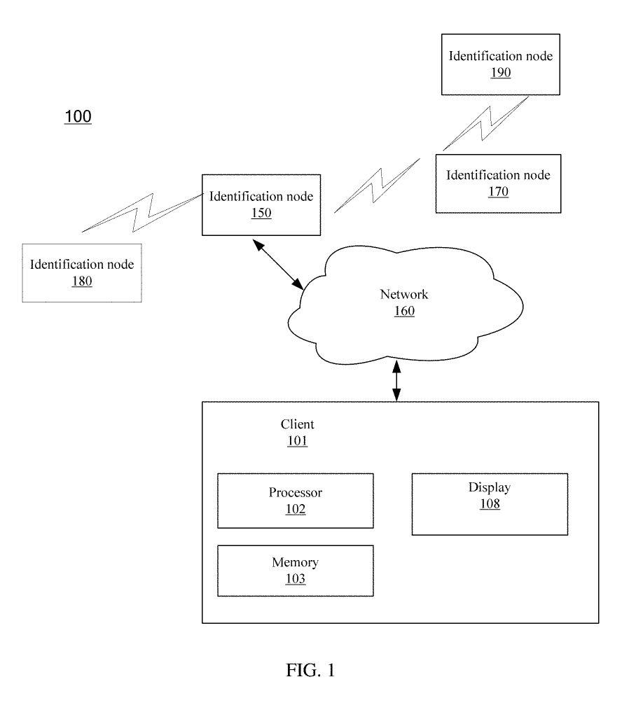

As shown in FIG. 1, an escape route generating system 100 comprises: a client 101 and a plurality of identification nodes (150, 170, 180, 190). In FIG. 1, only 4 identification nodes are shown, but it may be understood that, when the identification nodes are laid out in an actual building, the number of identification nodes may be designed according to a specific situation. The client 101 in FIG. 1 may be connected with any one of the 4 identification nodes and generate the escape route map through an installed application. In addition, any two nodes in the plurality of identification nodes may transmit latest temperature-related parameter information to each other using a wireless connection approach. For example: when a fire occurs, the client 101 identifies an identification node closest to itself, for example, the identification node 150 shown in FIG. 1, to establish a wireless connection; then the client 101 may acquire fire-parameter related data of all the identification nodes that is stored on the identification node 150 via the wireless connection, and the data is acquired from the other 3 identification nodes shown in FIG. 1 by the identification node 150 via the wireless connection; and finally, the client 101 generates a corresponding escape route map according to the received fire parameter information and provides the escape route map.

Related structures and functions of the identification nodes and the client shown in FIG. 1 in an embodiment are described in details below.

The identification nodes (150, 170, 180, 190) in FIG. 1 are identified by identification information. For example, the identification information may be a two-dimensional code identifier. The identification information may be further used for storing an initial route map. The initial route map stored on the identification node is used for showing all passageways in the building, for example, an aisle, a staircase or other safe passageways on each floor and locations where all the identification nodes are laid out in the building. In addition, the identification node further has functions showing below at a same time: firstly, any one of the identification nodes is further configured to receive and store temperature-related data from the other identification nodes, and then acquire the fire parameter information of the node itself. For example, the fire parameter information of the node itself includes: temperature data detected by the node itself and temperature data from the other identification nodes. Secondly, each identification node is further configured to: establish a wireless connection with the client 101 in response to identification of the client 101. The client 101 shown in FIG. 1 is configured to: acquire the fire parameter information and the initial route map by identifying the identification information of the identification node; generate the escape route map according to the fire parameter information and the initial route map. For example, the escape route map may be generated and provided by related software installed on the client 101.

In some embodiments, each identification node transmits the temperature-related data of the node itself to neighboring identification nodes using a successive delivering approach, so that finally all the respective identification nodes capable of normal communication have the fire parameter information stored thereon. For example, a distance by which a certain identification node transmits its stored temperature data to a neighboring identification node is associated with a communication protocol used.

In some embodiments, the temperature data stored in a respective identification node is periodically transmitted by the identification node itself to adjacent identification nodes, and the temperature data includes temperature data of a region where the identification node itself is located and temperature data from the other nodes, so that all the respective identification nodes capable of normal communication have the temperature data related to the fire parameter information stored thereon timely. Or, when the identification node establishes the wireless connection with the escape route generating device, i.e., the client 101 shown in FIG. 1, the identification node transmits a request instruction to the neighboring identification nodes, so as to acquire the temperature data related to the fire parameter information from the neighboring identification nodes.

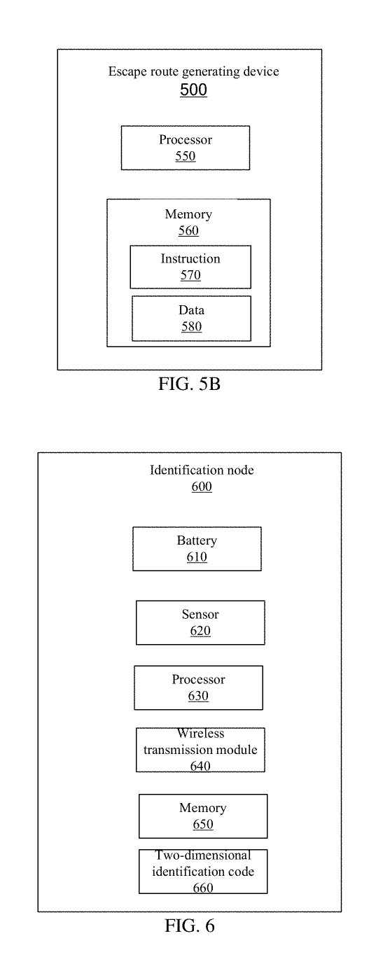

In some embodiments, the identification node may be a smart apparatus. Such a smart apparatus includes a processor, a battery, a sensor and a wireless transmitting device, for which FIG. 6 may be specifically referred to. Among them, the processor may be a relatively simple low-cost chip. The low-cost chip is responsible for processing an ambient temperature detected by a temperature sensor, and then identifying a fire situation surrounding the identification node according to an algorithm pre-set in the chip, for which related functional modules in FIG. 5A may be specifically referred to. When a fire occurs, the processor transmits the acquired fire situation data to the adjacent identification nodes through the wireless transmitting device on the identification node. Thus, a passage situation about the identification node itself may be informed to the adjacent identification nodes. At the same time, the identification node itself may also receive the fire parameter information transmitted from the adjacent identification nodes.

In some embodiments, an identification node is accompanied by a two-dimensional code. When a fire occurs, an escaper may scan the two-dimensional code on the identification node with a camera of a client 101 (e.g., a mobile phone). Then, a wireless hotspot connection is automatically performed by the client 101 internally according to content of the two-dimensional code. For example, content of the two-dimensional code may include name information of the wireless hotspot, a position where the identification code is located, and the like. The identification node may aggregate the information of the identification node itself and information sent from all other identification nodes through the established connection, and then transmit the aggregated information to the client 101.

In some embodiments, interconnection between a client 101 and an identification node is implemented through a network 160. For example, the network 160 includes, but is not limited to, a mobile communication access network (e.g., 4G, 3G), a wide area network or a local area network (e.g., WIFI), etc. For another example, the network 160 further includes the Internet.

In some embodiments, a client 101 may be a computing apparatus that includes a processor and a memory. For example, the client 101 may be a smart phone or another terminal including a processor and a memory (e.g., a mobile terminal).

In some embodiments, a client 101 as shown in FIG. 1 may include a processor 102, a memory 103, a display 108, an input apparatus (e.g., a microphone), an output apparatuses (e.g., a loudspeakers), and other components.

The processor 102 may process data signals. The data signals may include various computational structures, for example, a complex instruction set computer (CISC) structure, a reduced instruction set computer (RISC) structure, or a structure that implements a variety of instruction set combinations. In some examples, the processor 102 may also be a microprocessor.

The memory 103 may store instructions and/or data executed by the processor 102. These instructions and/or data may include code for implementing some functions or all functions of one or more of the modules as described in the embodiments of the present disclosure, for example, corresponding code for executing the method for generating the escape route. For example, the memory 103 includes a dynamic random access memory (DRAM), a static random access memory (SRAM), a flash memory, an optical memory, or other memory known to those skilled in the art.

The display 108 may be used for displaying data, and in this example, may be used for displaying the generated escape route. For example, the display 108 may be an LCD display, an LED display, or another display. The display 108 may also be a display screen having a touch function.

When the escape route generating system 100 of FIG. 1 is used to provide a user with the escape route, a central control system is not needed, and it is not needed to interconnect all the identification nodes simultaneously. Each identification node disclosed in the embodiments is powered independently, so that each identification node may still operate in an abnormal situation such as a fire or the like. In this case, the user may directly use his/her own client (for example, a mobile phone) to establish connection with the identification node closest to himself or herself, and the escape route is generated according to the data acquired through the connection.

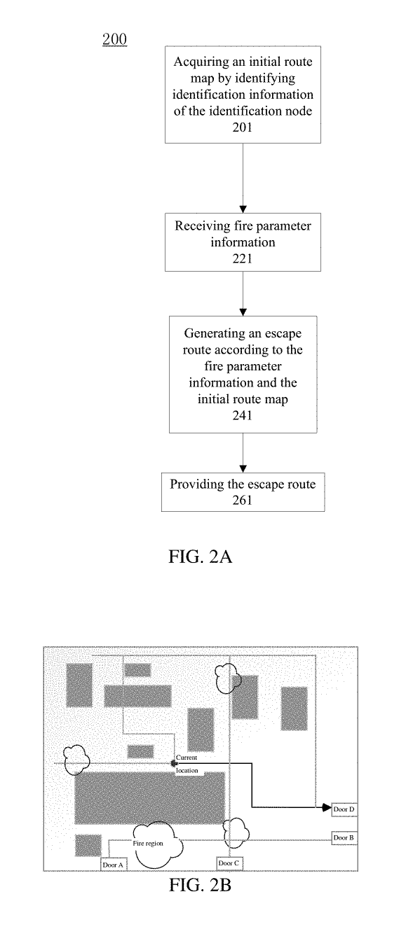

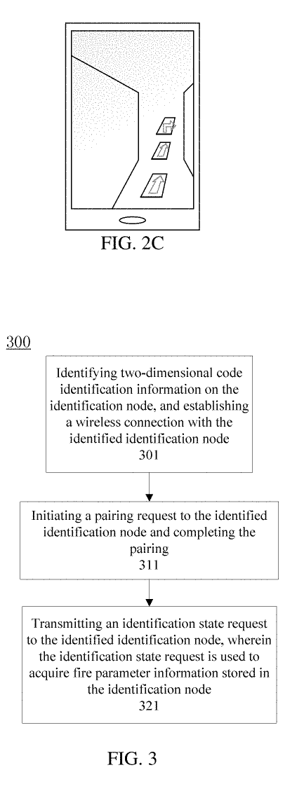

Hereinafter, an escape route generating method provided by an embodiment of the present disclosure will be described in conjunction with FIG. 2 to FIG. 4, an escape route generating device 500 provided by an embodiment of the present disclosure will be described in conjunction with FIG. 5A to FIG. 5B, and an identification node 600 provided by an embodiment of the present disclosure will be described in conjunction with FIG. 6.

As shown in FIG. 2, an embodiment of the present disclosure provides an escape route generating method 200, and the escape route generating method may be applied on a client 101 of FIG.1. For example, the escape route generating device 500 (as shown in FIG. 5A or FIG. 5B) located on the client 101 may implement escape route generation and guidance by using the escape route generating method 200.

With reference to FIG. 2, the escape route generating method 200 comprises: step 201, acquiring an initial route map by identifying identification information of an identification node; step 221, receiving fire parameter information; step 241, generating an escape route according to the fire parameter information and the initial route map; and step 261, providing the escape route.

In an embodiment of the present disclosure, the identification information at step 201 may specifically include a two-dimensional code. In this case, the client or the escape route generating device may establish a wireless connection with the identification node by identifying the two-dimensional code on the identification node. A type of the established wireless connection may include, but is not limited to, a wifi connection or Bluetooth connection. In addition, the initial route map in step 201 may be information stored in the two-dimensional code, and the initial route map is used for displaying all safety passageways in the building and identification nodes laid out in respective positions in the building.

In an embodiment of the present disclosure, the fire parameter information in step 221 may include temperature data from each identification node, and may also include passage result information from each identification node. For example, each identification node may respectively use a binary digit to identify two states, i.e., passable or impassable, of the identification node itself. Then, both the amount of the temperature data or the number of the binary digits included in the fire parameter information in step 221 may be smaller than or equal to a total number of identification nodes on the initial route map. This is because some of the identification nodes may be damaged due to a serious fire, so that the damaged identification nodes may not be able to transmit their own temperature-related data to the other identification nodes. This further results in that the identified identification node may not have the temperature-related data of the damaged identification nodes stored thereon. Finally, in step 221, the fire parameter information may be data that has been already stored on the identified identification node when the identification node is identified. For example, the respective identification nodes may periodically transmit their own data related to the fire parameter information. Or, the fire parameter information may be data obtained from a process of timely starting and transmitting the related data in a one-level-to-one-level spread-out approach when a related node detects occurrence of a fire. In addition, the fire parameter information may further be acquired by a process: after the client identifies the identification node (for example, the user scans the identification information of the identification node with the camera of the mobile phone), the identified identification node collects the fire parameter information in a one-level-to-one-level spread-out approach from adjacent identification nodes.

In an embodiment of the present disclosure, generating the escape route according to the fire parameter information and the initial route map in step 241 may include: acquiring a passage situation of each identification node according to the fire parameter information, and marking passable identification nodes on the initial route map to acquire the escape route. For example, when a certain identification node is determined to be an impassable identification node, all routes that need to pass through the identification node are treated as non-escape routes to further reduce the amount of data to be processed, which is particularly applicable to a scenario in which power of a mobile phone terminal is low. In addition, in order to apply the technical solutions, it is needed to for the identification node to provide all possible complete escape routes while providing the initial route map.

In an embodiment of the present disclosure, in step 241, the escape route may be generated or provided according to a plurality of preset priorities. For example, firstly, it is determined whether or not there is an optimal escape route including identification nodes with no fire occurrence; if there is an optimal escape route, the optimal escape route is preferentially provided to a user as a generated escape route; if there is no optimal escape route, an escape route with a relatively high safety factor is provided to the user as a sub-optimal escape route. For example, respective identification nodes on the sub-optimal escape route are all identification nodes with safety passages which are determined to be bearable by a human body according to the fire parameter information. If there is neither the optimal escape route nor the sub-optimal escape route, then an escape route consuming the shortest time is taken as a final escape route. For example, on each escape route there is an identification node with a temperature exceeding a temperature at which a human body can endure. With respect to the final escape route, it is needed to simultaneously transmit prompt information to the user to inform a possible consequence. For example, a voice prompt or a text prompt, etc., may be provided for the user to make his/her own final choice.

In an embodiment of the present disclosure, in step 261, the escape route may be provided in an approach of a map. For example, a plurality of escape routes may be provided simultaneously, and different escape routes may be distinguished by different colors. With respect to this solution, a user input interface may further be provided, so that the user may select a certain escape route. In addition, in step 261, escape route guidance may further be performed by arranging arrows on a real scene, and then the generated escape route is provided. Advantages of the solution include that the escape route may be displayed intuitively, which is especially applicable to people who have difficulty in reading maps. In addition, in step 261, the voice prompt may be further generated in an approach of navigation prompts, to further provide guidance on the escape route in real time. The escape route is provided in the approach of voice prompts, which may allow the user to escape more conveniently, and is more feasible for poor escape environments and environments with poor ambient light. In addition, in step 261, when more than one escape route map is provided on the client, an interactive interface may also be provided for the user to select a final escape route by himself/herself.

For example, providing the escape route in step 261 may include: acquiring an image at a position where the identification node is located; and performing direction guidance with arrows on the image. In addition, in step 261, the generated escape route map may be displayed on a display of the client. For example, an approach in which the display displays the escape route may be further divided into two modes: a first mode is to provide a map-type escape route, for which FIG. 2B may be specifically referred to; a second mode is that in a case that the user is not able to read and understand the scene when previewing the map, at this time, it is needed to indicate the direction of escape in real time on the client. Specifically, the user may use the camera of the client (for example, the mobile phone) to shoot the periphery of the identification node, and then three-dimensional arrow guidance is provided according to a relevant object at the identification node or a relative shape of an exit, for which FIG. 2C may be specifically referred to.

Specific implementations of step 201 and step 221 shown in FIG. 2 are illustrated in conjunction with FIG. 3 in the following.

An embodiment of the present disclosure provides a method 300 for acquiring a fire parameter with Bluetooth wireless connection; however, it may be understood that, the Bluetooth connection here is only one specific implementation approach of wireless connection, but wifi or other wireless approaches may also be used for connection.

Steps in FIG. 3 include a step of establishing the wireless connection and a step of acquiring the fire parameter. In addition, in order to generate the escape route map, relevant contents for the other steps not involved in this embodiment may be referred to in FIG. 2.

The method 300 for acquiring the fire parameter provided by FIG. 3 specifically includes: step 301, identifying two-dimensional code identification information on an identification node, and establishing a wireless connection with the identification node identified thereby; step 311, initiating a pairing request to the identified identification node and completing the pairing; and step 321, transmitting an identification state request to the identified identification node, so that it is able to acquire fire parameter information from the identified identification node.

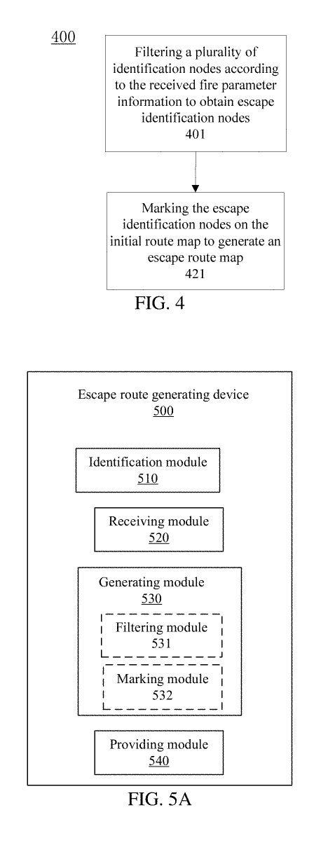

Specific implementation of step 241 shown in FIG. 2 is described below in conjunction with FIG. 4.

An initial route map according to this embodiment includes: passageways arranged and identification nodes laid out in respective floors. The fire parameter information includes: temperature-related information sensed by the respective identification nodes at regions where the identification nodes are located.

The method for generating the escape route according to the fire parameter information and the initial route map provided by FIG. 4 specifically includes: step 401, filtering the identification nodes laid out on the initial route map according to the received fire parameter information, to obtain escape identification nodes; and step 421, marking the escape identification nodes on the initial route map to generate the escape route map. Specifically, passable identification nodes are marked on the initial route map according to the fire parameter information, and the escape route map is composed by these passable identification nodes. Two specific examples are provided below to illustrate the escape route generating method of FIG. 3.

Example One: a plurality of identification nodes all respectively detects their temperature data in regions where they are located. When the fire parameter information includes the temperature data from the plurality of identification nodes, a specific process of filtering the identification nodes laid out on the initial route map to obtain the escape identification nodes may include: taking identification nodes whose detected temperature data is lower than a safety threshold as the escape identification nodes, and deleting identification nodes whose detected temperature data is higher than the safety threshold, in which when a total amount of the temperature data is smaller than a total number of the identification nodes laid out on the initial route map, identification nodes having no temperature data corresponding thereto are deleted.

Example Two: the plurality of identification nodes all respectively detect the temperature data in the regions where they are located, and generate corresponding binary data according to their detected temperature data. When the fire parameter information includes the binary data from the plurality of identification nodes, the specific process of filtering the identification nodes laid out on the initial route map to obtain the escape identification nodes may include: taking identification nodes each with a binary digit of “1” as escape identification nodes, if the digit “1” is used by all the identification nodes to represent their passable states; or, taking identification nodes each with a binary digit of “0” as escape identification nodes, if the digit “0” is used by all the identification nodes to represent their passable state.

Embodiment One is provided below in conjunction with the above content.

### Embodiment One

In this embodiment, an escape route generating device is located on a mobile phone, and a wireless connection established between the mobile phone and an identification node is Bluetooth connection. In addition, in this embodiment, only after an identification node is identified, the identified identification node starts to collect data related to fire parameter information; and in this embodiment, the data related to the fire parameter information is temperature data sensed by respective nodes.

Firstly, when a fire is encountered, the mobile phone is used for scanning two-dimensional code information of the identification node to establish the Bluetooth connection, where the two-dimensional code information at least includes an initial route map (without a fire state). For example, the two-dimensional code information may further include ID information of the identification node.

Then, the mobile phone is directly connected with the scanned identification node in a role of a master device, to initiate a pairing request and complete the pairing. Then, the mobile phone transmits an identification state request instruction to the identified identification node. The identification node transmits the fire parameter information to the mobile phone in response to the instruction.

Thereafter, an application (app) related to generation of the escape route installed on the mobile phone provides a graphical map state information according to received aggregated data (i.e. the fire parameter information). That is, the app marks states of respective identification nodes on the initial route map according to the aggregated fire parameter information, acquires an escape route map and displays the escape route map on a screen.

When the mobile phone collects information of all the identification nodes, it performs route algorithm filtering in the application. A favorable principle of generating the escape route map from the mobile phone may be: selecting a nearest route without fire, and generating a route map to inform an escaper. However, when there is no route without fire, the escape route may be obtained in an approach of comprehensive comparison, and a specific algorithm may be that: the mobile phone may analyze to obtain an optimal route according to floor information, the number of identification nodes distributed on a path, information of entrances and exits, regional temperatures measured by the identification nodes, and other parameter information. For example, it is assumed that a position where a user is located is a fifth floor, the fire occurs on a sixth floor, and there are two escape routes in the building available for selection, Route A and Route B, respectively. Route A needs to pass through 32 identification nodes, a highest temperature in the 32 identification nodes reaches 60 degrees; and Route B needs to pass through 44 identification nodes, and a highest temperature of the 44 identification nodes is 45 degrees. In this example, the mobile phone may preferentially select the route with the 32 identification nodes as the escape route, and perform guidance according to the escape route. That is, the escape route is obtained in comprehensive consideration of a degree of the temperature and a total number of the identification nodes.

It should be noted that, if a certain identification node has an excessively high temperature collected by a temperature sensor, or is directly damaged by fire, it is determined the identification node to be a damaged identification node. In this case, the mobile phone may determine that routes including the damaged identification node are problematic, so that all routes that need to include the damaged identification node are ignored.

Finally, the escaper may also perform real scene shooting through the camera, and then escape route guidance is performed through three-dimensional arrows on a real scene map.

Hereinafter, how the identification node collects the data related to the fire parameter in Embodiment One will be illustrated in details. The process may be initiated as the identification node is identified, or may also be initiated as the identification node periodically and actively starts a scanning process.

For example, when the identification node actively starts the scanning process, the process of collecting the data related to the fire parameter information may include: initiating, by the identification node, an identification state request to other related identification nodes. In this case, it is assumed that connection between the identification nodes is Bluetooth connection; as a master apparatus, the identification node transmitting the request may transmit the state request to adjacent identification nodes, and similarly, the adjacent identification nodes may in turn transmit the state request successively to other identification nodes, so as to spread out and deliver the identification state request throughout all the available identification nodes (e.g., referred to as a one-level-to-one-level spread-out approach). After the identification node transmitting the request collects state information of all the other identification nodes, information collection is completed. For example, there are 4 other identification nodes, respectively: identification Node 1, 23 degrees; identification Node 2, 25 degrees; identification Node 3, ERROR; identification Node 4, 54 degrees. Then the identification node starting the scanning process obtains the fire parameter information according to the collected information.

For another example, the client may firstly identify the identification node. When the identified identification node transmits a state information acquisition request to the adjacent identification nodes, then the adjacent identification nodes may also deliver a state information acquisition request in turn to other identification nodes (e.g., referred to as a one-level-to-one-level spread-out approach), and so on and so forth. Finally, the identified identification node may acquire the data related to the fire parameter information from all the other identification nodes.

It should be understood that, the above-described Embodiment One is only a specific implementation approach. For example, wifi and other wireless connection may also be used for replacing the Bluetooth connection in Embodiment One. The data transmitted between the identification nodes in Embodiment One may not be the temperature data, but passage result data determined by respective identification nodes. For example, the digit “1” may be used for representing that the identification node is passable, the digit “0” may be used for representing that the identification node is impassable, and then the binary digits are transmitted to other identification nodes. The method by using the respective identification nodes to periodically and automatically acquire the data related to the fire parameter information of other identification nodes may enable the mobile phone to immediately obtain the fire parameter information after the connection between the mobile phone and the identification node is established. This embodiment is merely exemplarily illustrated, and related solutions obtained by those skilled in the art based on the concept of the present disclosure should all fall within the protection scope of the present disclosure.

As shown in FIG. 5A, at least an embodiment of the present disclosure further provides an escape route generating device 500. The escape route generating device 500 may comprise: an identification module 510, configured to acquire an initial route map by identifying identification information of an identification node; a receiving module 520, configured to receive fire parameter information; a generating module 530, configured to generate an escape route according to the fire parameter information and the initial route map; and a providing module 540, configured to provide the escape route.

In some embodiments, the identification module 510 is further configured to: identify two-dimensional code identification information on the identification node, and establish Bluetooth connection with the identification node. In this case, the receiving module 520 is correspondingly configured to: initiate a pairing request to the identified identification node by the established wireless (e.g., Bluetooth) connection, and complete the pairing; transmit an identification state request to the identified identification node, where the identification state request is used for acquiring the fire parameter information from the identified identification node.

In some embodiments, the identification module 510 is further configured to: identify the two-dimensional code identification information on the identification node and establish wifi connection with the identification node. In this case, the receiving module 520 is correspondingly configured to: initiate a pairing request to the identified identification node by the established wifi connection, and complete the pairing; transmit an identification state request to the identified identification node, where the identification state request is used for acquiring fire parameter information from the identified identification node.

In some embodiments, an initial route map includes: passageways arranged in respective floors and identification nodes laid out in respective floors. The fire parameter information includes: temperature-related information sensed by the respective identification nodes at regions where the identification nodes are located.

In some embodiments, the generating module 530 may further include: a filtering module 531, configured to filter identification nodes laid out on the initial route map according to the received fire parameter information to obtain escape identification nodes; and a marking module 532, configured to mark the escape identification nodes on the initial route map to generate the escape route map.

In some embodiments, the fire parameter information includes temperature data from a plurality of identification nodes, where a total amount of the temperature data is smaller than or equal to a total amount of the identification nodes laid out on the initial route map. In this case, the filtering module 531 is configured to: take identification nodes whose sensed temperature data is lower than a safety threshold as escape identification nodes, and delete identification nodes whose sensed temperature data is higher than the safety threshold, wherein, when a total amount of the temperature data is smaller than a total amount of the identification nodes laid out on the initial route map, identification nodes having no temperature data corresponding thereto are deleted.

In some embodiments, the fire parameter information includes binary data from a plurality of identification nodes, and a total number of digits of the binary data is smaller than or equal to a total amount of the identification nodes laid out on the initial route map, where each binary digit in the binary data is used for representing whether or not a corresponding identification node is passable. The filtering module 531 is configured to: take identification nodes with a binary digit of 1 as escape identification nodes if the binary digit of 1 represents “passable”; or take identification nodes with a binary digit of 0 as escape identification nodes if the binary digit of 0 represents “passable”.

In some embodiments, the providing module is configured to: take an image in a position where the identified identification node is located; and perform direction guidance with arrows on the image.

FIG. 5B is another schematic diagram of the escape route generating device 500 provided by embodiments of the present disclosure. The escape route generating device 500 comprises: a processor 550 and a memory 560, where the memory 560 is used for storing instructions 570 and/or data 580. When the instructions 580 are executed by the processor 550, operations below are implemented, including: acquiring an initial route map, by identifying identification information of the identification node; receiving fire parameter information; generating an escape route according to the fire parameter information and the initial route map; and providing the escape route.

For example, when the instructions are executed by the processor 550, operations below are also implemented, including: identifying two-dimensional code information on the identification node, and establishing wireless connection with the identification node; initiating a pairing request to the identification node and completing the pairing; and transmitting an identification state request to the identification node, where the identification state request is used for acquiring the fire parameter information from the identification node.

For example, the initial route map includes: passageway information arranged respective floors and the identification nodes laid out in respective floors. The fire parameter information includes: temperature-related information sensed by the respective identification nodes at regions where the respective identification nodes are located.

For example, when the instructions are executed by the processor, operations below are also implemented, including: filtering the identification nodes laid out on the initial route map according to the received fire parameter information to obtain escape identification nodes; and marking the escape identification nodes on the initial route map to generate the escape route map.

For example, the fire parameter information includes temperature data from a plurality of identification nodes, where a total amount of the temperature data is smaller than or equal to a total amount of the identification nodes laid out on the initial route map.

For example, when the instructions are executed by the processor, operations below are also implemented, including: taking identification nodes whose temperature data is lower than a safety threshold as the escape identification nodes, deleting identification nodes whose temperature data is higher than the safety threshold; wherein, when a total amount of the temperature data is smaller than a total amount of the identification nodes laid out on the initial route map, identification nodes having no temperature data corresponding thereto are deleted.

For example, the fire parameter information includes the binary data from the plurality of identification nodes, a total number of digits of the binary data is smaller than or equal to a total amount of the identification nodes laid out on the initial route map, wherein, each binary digit in the binary data is used for representing whether or not a corresponding identification node is passable.

For example, when the instructions are executed by the processor, operations below are also implemented, including: taking identification nodes with a binary digit of 1 as escape identification nodes if the binary digit of 1 represents passable; or taking identification nodes with a binary digit of 0 as the escape identification nodes if the binary digit of 0 represents passable.

For example, when the instructions are executed by the processor, operations below are also implemented, including: taking an image in a position where the identification node is located; and performing direction guidance with arrows on the image.

As shown in FIG. 6, at least an embodiment of the present disclosure further provides an identification node 600, corresponding to the identification nodes 150, 160, 180 and 190 shown in FIG. 1. The identification node 600 may include: a battery 610, configured to supply power to the identification node; a sensor 620, configured to sense the temperature data around the identification node, the sensed temperature data being finally used for determining whether or not the identification node is passable; and a processor 630, configured to encapsulate the data sensed by the sensor according to a relevant wireless protocol. In some embodiments, a processor 610 is further configured to determine whether or not the identification node is passable according to temperature data sensed by the sensor 620, and transmit a determination result as a portion of the fire parameter information, i.e., the determination result being a certain digit of data of the fire parameter information stored in the identified identification node.

The identification node 600 may further include: a wireless transmission module 640, configured to transmit data related to the fire parameter information output by the processor 610 according to wireless connection established with a client, the client being installed with an escape route generating device. The wireless transmission module 640 is further configured to transmit temperature-related data sensed by the identification node and ID information of the identification node to an adjacent identification node. The identification node 600 further comprises a memory 650, configured to store data from the other identification nodes and the fire parameter information acquired according to these data. The memory 650 transmits the stored data to the wireless transmission module 640 for transmission. The identification node 600 further includes a two-dimensional identification code 660 set for the identification node, and the client may establish wireless connection with the identification node by scanning the two-dimensional identification code 660. In addition, the two-dimensional identification code 660 also stores an initial route map, and the initial route map shows the passageways and all the identification nodes laid out within the building. When the client scans the two-dimensional identification code 660, the initial route map stored therein may be read.

In some embodiments, the identification node 600 may further include a plurality of interfaces, and these interfaces may be connected with the other electronic apparatuses, to allow the electronic apparatuses to read the related data stored therein. Or, an electronic apparatus may input an updated initial route map by a related interface; for example, when changes occur to the number or locations of the laid-out identification nodes, it is needed to update the initial route map.

In some embodiments, the wireless transmission module 640 includes: a wireless transmitting apparatus such as a modem and an antenna.

In some embodiments, the memory 650 may store instructions and/or data executed by the processor 630. These instructions and/or data may include code for implementing some functions or all functions of one or more of the modules as described in the embodiments of the present disclosure. For example, the memory 650 includes a dynamic random access memory (DRAM), a static random access memory (SRAM), a flash memory, an optical memory, or other memory known to those skilled in the art.

In some embodiments, the sensor 620 may further include a sensor for detecting an amount of smoke.

In some embodiments, the two-dimensional identification code 660 may specifically be a stacked or tiered two-dimensional bar code, or a matrixed two-dimensional bar code.

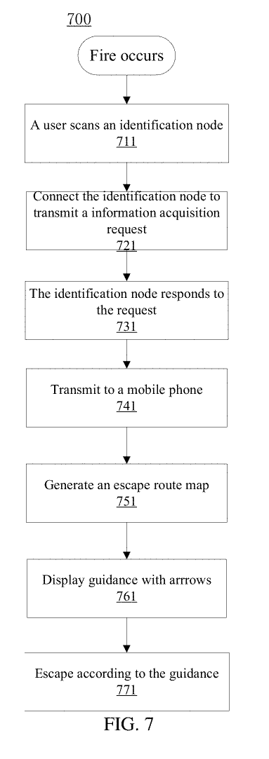

Embodiment Two is provided below in conjunction with FIG. 7.

### Embodiment Two

An escape route generating device in the embodiment below is an application installed on a mobile phone.

When a fire occurs, a mobile phone user uses a camera to scan and identify a two-dimensional identification code on an identification node (step 711), to establish wireless connection. Then the mobile phone transmits a fire information acquisition request instruction to the identified identification node through the established connection (step 721). Thereafter, the identification node responds to the instruction (step 731), and transmits fire parameter information to the mobile phone (step 741). The mobile phone receives the fire parameter information and then generates the escape route map (step 751). Finally, arrows are used for guiding an escape route (step 761), and the mobile phone user escapes according to the guidance (step 771).

For implementation details not described in Embodiment Two, related methods described in conjunction with FIG. 2 to FIG. 4 may be referred to. For example, with respect to how the mobile phone in Embodiment Two generates the escape route map with the fire parameter information, related methods described in conjunction with FIG. 2 to FIG. 4 may be referred to. With respect to a specific type of the fire parameter information and acquisition thereof in Embodiment Two, the above-described methods may also be used.

The various embodiments described herein may be implemented with a computer-readable media, for example, computer software, hardware, or any combination thereof. With respect to implementation with the hardware, the embodiments described herein may be implemented by at least one of an Application-Specific Integrated Circuit (ASIC), a Digital Signal Processor DEVICE (DSPD), a Programmable Logic Device (PLD), a Field-Programmable Gate Array (FPGA), a processor, a controller, a microcontroller, a microprocessor, an electronic unit designed to execute the functions described herein, and in some cases, such embodiments may be implemented in a processor unit. With respect to implementation with the software, the embodiments, such as the process or the function, may be implemented by a separate software module that allows execution of at least one function or operation. A software code may be implemented by a software application (or program) written in any suitable programming language, and the software code may be stored in the memory and executed by the processor unit.

Those ordinarily skilled in the art may be aware of that, the devices and algorithm steps according to various examples described in conjunction with the embodiments in the present disclosure, may be implemented by electronic hardware, or a combination of computer software and electronic hardware. It depends on constraints to particular applications and design of the technical solutions whether these functions are performed in the form of hardware or software. Those skilled in the art can use different methods for the respective particular applications to achieve the described functions, but such implementation shall not be regarded as exceeding the scope of the present disclosure.

Those skilled in the art can clearly understand that, for convenience and conciseness of description, specific working processes of apparatuses and devices described above, can refer to corresponding processes in the embodiments of the foregoing methods, which will not be repeated here.

In the several embodiments provided by the present disclosure, it shall be appreciated that the disclosed device and method can be implemented in other approaches. For example, the aforesaid apparatus embodiments are given by way of illustration only, e.g., the division of the units is only a logic functional division, and may be conducted in other dividing manners in practical implementation, for example, a plurality of units or components can be combined or integrated into another device, or some of the features may be ignored or not performed.

The units illustrated as separating parts may be physically separated or may be not physically separated, and parts displayed as the units may be physical units or may not be physical units. Part or all units may be selected according to an actual demand to achieve the purpose of the solution of this embodiment.

The function may be stored in one computer readable storage medium when being implemented in a manner of the software functional unit and being sold or used as an independent product. Based on such understanding, the technical solutions of the present disclosure in essence, or part contributing to the prior art, or part of the technical solutions, may be embodied in the form of a software product, which can be stored in a storage medium, including several instructions to enable a computer device (which may be a personal computer, a server or a network device) to execute the part of or all of steps in the method according to the respective embodiments of the present disclosure. The foregoing storage medium comprises various mediums such as a U disk, a mobile hard disk, a read-only memory, a random access memory, a diskette or a compact disc capable of storing the program codes.

What are described above is related to the illustrative embodiments of the disclosure only and not limitative to the scope of the disclosure; any changes or replacements easily for those technical personnel who are familiar with this technology in the field to envisage in the scopes of the disclosure, should be in the scope of protection of the present disclosure. Therefore, the scopes of the disclosure are defined by the accompanying claims.

The present application claims the priority of the Chinese Patent Application No. 201710002108.8 filed on Jan. 3, 2017, which is incorporated herein by reference in its entirety as part of the disclosure of the present application.

1. An escape route generating device, comprising: a processor and a memory, wherein the memory is used for storing instructions, and when the instructions are executed by the processor, operations are implemented including:
acquiring an initial route map by identifying identification information of an identification node;
receiving fire parameter information;
generating an escape route according to the fire parameter information and the initial route map; and
providing the escape route.

2. The escape route generating device according to claim 1, wherein when the instructions are executed by the processor, further operations are implemented including:
identifying two-dimensional code information on the identification node, and establishing a wireless connection with the identification node; and
initiating a pairing request to the identification node and completing the pairing, and transmitting an identification state request to the identification node, the identification state request being used for acquiring the fire parameter information from the identification node.

3. The escape route generating device according to claim 1, wherein:
the initial route map includes passageway information arranged and identification nodes laid out in respective floors; and
the fire parameter information includes temperature-related information sensed by respective identification nodes in regions where the respective identification nodes are located.

4. The escape route generating device according to claim 3, wherein when the instructions are executed by the processor, further operations are implemented including:
filtering the identification nodes laid out on the initial route map according to the received fire parameter information to obtain escape identification nodes; and
marking the escape identification nodes on the initial route map to generate an escape route map.

5. The escape route generating device according to claim 4, wherein:
the fire parameter information includes temperature data from a plurality of identification nodes, wherein a total amount of the temperature data is smaller than or equal to a total amount of the identification nodes laid out on the initial route map.

6. The escape route generating device according to claim 5, wherein when the instructions are executed by the processor, further operations are implemented including:
taking identification nodes whose temperature data is lower than a safety threshold as the escape identification nodes, and deleting identification nodes whose temperature data is higher than the safety threshold, wherein when the total amount of the temperature data is smaller than the total amount of the identification nodes laid out on the initial route map, identification nodes having no temperature data corresponding thereto are deleted.

7. The escape route generating device according to claim 3, wherein:
the fire parameter information includes binary data from the plurality of identification nodes, a total number of digits of the binary data is smaller than or equal to the total amount of the identification nodes laid out on the initial route map, and each binary digit in the binary data is used for representing whether or not a corresponding identification node is passable.

8. The escape route generating device according to claim 7, wherein when the instructions are executed by the processor, further operations are implemented including:
taking an identification node with a binary digit of 1 as an escape identification node if the binary digit of 1 represents “passable”; or
taking an identification node with a binary digit of 0 as the escape identification node if the binary digit of 0 represents “passable”.

9. The escape route generating device according to claim 1, wherein when the instructions are executed by the processor, further operations are implemented including:
taking an image in a position where the identification node is located, and performing direction guidance with an arrow on the image.

10. An escape route generating system comprising: an identification node, and the escape route generating device according to claim 1; wherein:
the identification node is represented by identification information, and the identification information is used for storing an initial route map;
the identification node is further configured to receive and store temperature-related data from other identification nodes, and acquire fire parameter information of the identification node; and
each of the identification nodes is further configured to establish a wireless connection in response to identification of the escape route generating device.

11. The escape route generating system according to claim 10, wherein:
each identification node located on the initial route map transmits the temperature-related data stored in the identification node to neighboring identification nodes in a one-level-to-one-level spread-out approach, so that each identification node located on the initial route map has the fire parameter information stored thereon.

12. The escape route generating system according to claim 11, wherein:
each identification node periodically transmits the temperature-related data related to a region where the identification node is located to adjacent identification nodes.

13. The escape route generating system according to claim 11, wherein:
when a certain identification node establishes the wireless connection with the escape route generating device, the certain identification node then transmits a request instruction to an adjacent identification node so as to acquire the temperature data related to the fire parameter information.

14. An escape route generating method, comprising:
acquiring an initial route map by identifying identification information of an identification node;
receiving fire parameter information;
generating an escape route according to the fire parameter information and the initial route map; and
providing the escape route.

15. The escape route generating method according to claim 14, further comprising:
identifying two-dimensional code identification information on the identification node, and establishing a wireless connection with the identification node;
wherein the receiving fire parameter information includes:
initiating a pairing request to the identification node and completing the pairing; and
transmitting an identification state request to the identification node, wherein the identification state request is used for acquiring the fire parameter information from the identification node.

16. The escape route generating method according to claim 14, wherein:
the initial route map includes passageway information arranged and identification nodes laid out in respective floors;
the fire parameter information includes temperature-related information sensed by respective identification nodes at regions where the respective identification nodes are located; and
the generating an escape route according to the fire parameter information and the initial route map, includes:
filtering the identification nodes laid out on the initial route map according to the received fire parameter information to obtain escape identification nodes; and
marking the escape identification nodes on the initial route map to generate an escape route map.

17. The escape route generating method according to claim 16, wherein:
the fire parameter information includes temperature data from a plurality of identification nodes, and a total amount of the temperature data is smaller than or equal to a total amount of the identification nodes laid out on the initial route map; and
the filtering the identification nodes laid out on the initial route map according to the received fire parameter information to obtain escape identification nodes, includes:
taking identification nodes whose temperature data is lower than a safety threshold as escape identification nodes, deleting identification nodes whose temperature data is higher than the safety threshold;
wherein when the total amount of the temperature data is smaller than the total amount of the identification nodes laid out on the initial route map, identification nodes having no temperature data corresponding thereto are deleted.

18. The escape route generating method according to claim 16, wherein:
the fire parameter information includes binary data from the plurality of identification nodes, a total number of digits of the binary data is smaller than or equal to a total amount of the identification nodes laid out on the initial route map, and each binary digit in the binary data is used for representing whether or not a corresponding identification node is passable.

19. The escape route generating method according to claim 18, wherein the filtering the identification nodes laid out on the initial route map according to the received fire parameter information to obtain escape identification nodes, includes:
taking an identification node with a binary digit of 1 as an escape identification node if the binary digit of 1 represents passable; or
taking an identification node with a binary digit of 0 as the escape identification node if the binary digit of 0 represents passable.

20. The escape route generating method according to claim 14, wherein the providing the escape route includes:
acquiring an image in a position where the identification node is located; and
performing direction guidance with an arrow on the image.
